(19) United States
(12) Patent Application Publication
(10) Pub. No.: US 2003/0120640 A1
(43) Pub. Date: Jun. 26, 2003

(54) Construction method of substance dictionary, extraction of binary relationship of substance, prediction method and dynamic viewer

(75) Inventors: Yoshihiro Ohta, Tokyo (JP); Tetsuo Nishikawa, Tokyo (JP); Shigeo Ihara, Tokorozawa (JP)

Correspondence Address: Stanley P. Fisher, Reed Smith LLP, Suite 1400, 3110 Fairview Park Drive, Falls Church, VA, 22042-4503, US

(73) Assignee: Hitachi. Ltd.

(21) Appl. No.: 10/194,228

(22) Filed: Jul. 15, 2002

(30) Foreign Application Priority Data
Dec. 21, 2001 (JP) 2001-389474

(51) Int. Cl. G06F 7/00

(52) U.S. Cl. 707/3

(57) ABSTRACT

The disclosed invention makes the following possible: automatically and efficiently extracting substance names such as genes, proteins, and low-molecular-weight substances and binary relations between substances from papers stored in databases and visually presenting the extracted binary relations in forms intelligible to users. First step is extracting protein names, synonyms, and cross reference information from public databases and integrating them into a protein dictionary. Second step is extracting binary relations, based on the patterns of sentences expressing a binary relation. To extract those screened out, inferring binary relations, using the weight vectors of substances appearing in text is also performed. Some significance values are defined and assigned to the thus extracted binary relations to help users to obtain binary relations serving the user's purpose. A threshold of significance values can be assigned by user so that the binary relations above or below the threshold can selectively be shown.

### BACKGROUND OF THE INVENTION

1. Field of the Invention

The present invention relates to methods for extracting substance names having interaction with another substance from papers concerning substances of any kind (genes, proteins, low-molecular-weight substances, etc.) stored in existing databases, inferring further relations between two substances, and visually presenting such relations.

2. Description of Related Art

A great number of researchers have presented the results of their study efforts about how substances such as genes, proteins, and low-molecular-weight substances act and the papers thereof are stored in databases. For genes, proteins, and low-molecular-weight substances, information about protein interaction between them is important. Due to a huge number of related papers stored in databases, it is hard for users to find protein interaction by looking through every paper. Therefore, attempts have been made to extract substance names described in the papers through automatic search of the databases in which the papers are stored and automatically extract relationship between two substances, that is, binary relation.

Conventionally, extracting protein names as an example of extracting substance names from documents has been carried out in this way: a protein dictionary is created into which all known protein names are registered; and literature is simply analyzed by natural language processing (NLP) to find a protein name included in the dictionary.

An increasing number of approaches to extracting any information from literature databases have lately been made. Most of these approaches are divided into those using natural language processing and those using keywords and formal rules. A typical approach using NLP is such that all words in a document are tagged with grammatical labels through syntax analysis using NLP of text obtained from a public database such as MEDLINE and binary relations are extracted by searching for the subject and object word of a verb representing binary relation. A typical approach using keywords is as follows. First, find out keywords that are often used to express interaction between substances. Next, analyze sentence structure to determine what pattern of sequence in which the keyword, substance names, preposition, etc. are put. Finally, search for sentences in which they appear in a certain pattern, using a dictionary of substance names and the defined patterns.

Some problems were posed for the conventional methods of extracting substance names, using a dictionary in which the substance names have been registered beforehand. In the fields of medical science and biology, a great number of substance names and synonyms expressing the same meaning of a substance are newly found. For example, each time a protein name is found out, it must be registered into the dictionary of protein names. Thus, it took so much time to construct a dictionary and a considerable number of errors of protein names were included in the dictionary. When extracting substance names, based on the dictionary only, it was unable to extract a complex protein name consisting of multiple words. Therefore, a method of extracting substance names, using a statistics approach was proposed. However, it just made it possible to extract a substance name consisting of a few words at most. Because a great number of complex substance names consisting of six or more words exist in the fields of medical science and biology, the above method was ineffective for practical use. In the statistics approach, in some cases, it was unable to extract protein names, due to subtle expression difference by different paper authors. Furthermore, a method in which both a protein dictionary and a pattern dictionary should be prepared to extract complex protein names was proposed. However, this method has many drawbacks; that is, accuracy depends on the quality of the protein dictionary, a pattern-learning corpus is not provided, and pre-processing is required for extracting complex names.

As concerns extracting binary relations between substances, for the conventional methods using either natural language processing or keywords, a great amount of data to be calculated and the lack of user-friendly interactivity were pointed out as problems. Furthermore, conventionally, binary relations between substances have been rendered as only text information. To understand complicated connections of binary relations, examination should be made by writing binary relations one by one on paper, which required much labor and time.

### SUMMARY OF THE INVENTION

An object of the present invention is to provide a method of automatically and efficiently extracting substance names such as genes, proteins, and low-molecular-weight substances and binary relations between substances from papers stored in databases, addressing the above problems of prior art. Another object of the present invention is to provide a method of visually presenting the extracted binary relations between substances in forms intelligible to users.

To extract substance names from descriptions in text, a method using a dictionary and a method based on prediction are used in combination in the present invention. The dictionary is constructed through direct input of substance names by biologists and automatic extraction of substance names from public databases. Automatic extraction of substance names from public databases is implemented such that protein names, synonyms, and cross-reference information are extracted from, for example, three public databases (SWISSPROT, PIR, and CSNDB) and integrated into a protein dictionary. In the present invention, protein names not registered in the dictionary are also extracted from descriptions in text by prediction.

In the present invention, from a set of texts stored in the public databases, binary relations between substances are extracted and presented. Extracting the binary relations is first performed, based on the patterns of sentences expressing a binary relation. To extract those screened out, inferring binary relations, using the weight vectors of substances appearing in text is also performed. Some significance values are defined and assigned to the thus extracted binary relations to help users to obtain binary relations serving the user's purpose.

In the present invention, to visually present the binary relations between substances, a dynamic viewer implemented in Java is used. As functions of the dynamic viewer, layout views (modes of layout of nodes) are provided so that the binary relations between nodes can be visually presented in different modes.

In accordance with the aspects of the present invention, methods provided by invention are enumerated below.

(1) A method of constructing a substance dictionary, the method comprising the steps of collecting a term group consisting of a substance name and its synonyms and cross-reference information specifying that two or more different names are used to refer to the same substance from a plurality of databases; comparing the thus collected term groups and combining the term groups including the same name or synonym; and combining the term groups expressing the same substance, using the cross-reference information.

(2) A method of constructing a substance dictionary as recited in item (1), wherein the above substance is a protein.

(3) A method of extracting a compound word expressing a substance name from text, the method comprising the steps of segmenting the text into token units and extracting a coined word (a main keyword) peculiar to the substance in compliance with a predetermined word formation rule and a word (function keyword) registered in a list of words predetermined to designate the function and property of the substance; in sentences of the text including a main keyword extracted, extending the main keyword by combining one or more symbols, words and phrases, other main keywords or function keywords preceding or following the main keyword with it, according to a predetermined rule; in sentences of the text, combining extracted main and function keywords or extracted main and function keywords and the thus extended main keyword into a noun phrase, according to a predetermined pattern.

The thus obtained noun phrase is not always a substance name. Noun phrases in error are automatically corrected if correctable, according to predetermined error correction rules. Noun phrases having errors that are automatically uncorrectable are output to a GUI (Graphical User Interface) so that biologists will determine whether they are substance names. Substance names extracted from text in the above method are registered into the above substance dictionary and used.

(4) A method of constructing a substance dictionary as recited in item (3), wherein the above substance is a protein.

(5) A method of extracting binary relations between substances from text, the method comprising the steps of preparing a dictionary into which nouns, each expressing a substance, have been registered; registering verbs, each expressing a binary relation between substances; manually or automatically collecting sentence patterns, each including one verb and two nouns, and creating automatons of the sentence patterns; retrieving text from databases; subjecting a sentence in the retrieved text to the process of one automaton on the condition that two nouns have been registered in the dictionary; and outputting the two nouns respectively expressing two substances and a verb expressing a binary relation between the substances when the sentence has been accepted by the automaton.

Other and further objects, features and advantages of the invention will appear more fully from the following description.

### BRIEF DESCRIPTION OF THE DRAWINGS

FIG. 1 is a flowchart for explaining extracting substance names;

FIG. 2 illustrates exemplary results of extracting substance names;

FIG. 3 illustrates an example of registering a protein name that has been output as an error candidate into a dictionary;

FIG. 4 is a flowchart explaining an overall process flow of extracting binary relations between substances and related steps;

FIG. 5 is a flowchart explaining an overall process flow of inferring binary relations between substances and related steps;

FIG. 6 is illustration explaining a relational template automaton concerning verb activate;

FIG. 7 illustrates an example of processing by an automaton;

FIG. 8 shows an exemplary layout view output by a dynamic viewer;

FIG. 9 illustrates dynamic view change by resource selection;

FIG. 10 shows a simple view example;

FIG. 11 shows an example of the shown property of a node on the simple view;

FIG. 12 shows examples of shown edge property and edge slider panel;

FIG. 13 shows an example of edge information shown;

FIG. 14 is illustration explaining layout view change by checkbox selection on the edge slider panel;

FIG. 15 shows a list view example;

FIG. 16 shows an explorer view example;

FIG. 17 shows an animate view example; and

FIG. 18 shows embodiment in which users can get information from a server via a network.

### DETAILED DESCRIPTION OF THE PREFERRED EMBODIMENTS

The present invention now is described fully hereinafter with reference to the accompanying drawings, in which preferred embodiments of the invention are shown. In the following, extracting proteins will be explained as an example of extracting substance names. The method of the present invention is also applicable to extracting other substance names such as genes and low-molecular-weight substances.

1. Extracting Substance Names

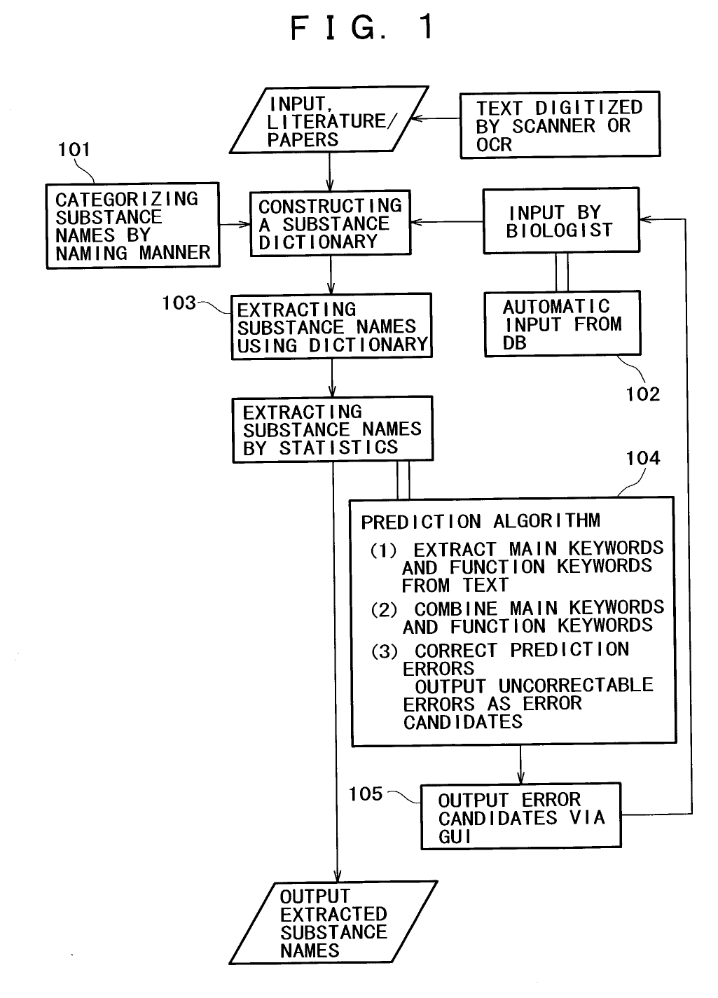

A process flow of constructing a dictionary of protein names and extracting substance names using the created dictionary in accordance with the invention is shown in FIG. 1.

In the present invention, a dictionary in which protein names have been registered is used to extract protein names from literature such as papers. Protein names can be registered into the dictionary in two ways in which experts (biologists) directly input protein names and in which protein names are automatically retrieved from public databases and registered into the dictionary.

Using only the dictionary in extracting protein names makes it impossible to extract synonyms that are different expressions of a protein, according to the authors of the referenced papers, the name of a protein of latest discovery, and the name of a protein not registered in the dictionary. In general, when naming substances such as genes, proteins, and low-molecular-weight substances, biologists often use diverse names to refer to one substance. Synonyms are such diverse names given to one substance. What synonyms exist are detailed in Section 1.1. Because naming a substance, or using what synonym thereof differs according to paper author, synonyms make it difficult to extract substance names from the papers. Therefore, predicting protein names is also performed to extract proteins not registered in the dictionary.

As for constructing the protein dictionary by biologists, registering protein names at random is inefficient. To construct the dictionary efficiently, protein names should be categorized by manner of naming proteins (step 101 in FIG. 1). This categorization can be applied to predicting protein names.

In extracting substance names, first, categorize substance names to be extracted by peculiar manner of naming as described above. Then, construct the dictionary through manual input by biologists or automatic input from a database, according to the category. Finally, extract substance names from the text, using the created dictionary. Substance names that cannot be extracted should be extracted by prediction for which a prediction algorithm is created, according to the category.

1.1 Peculiar Manners of Naming Proteins

Proteins are named mainly in the following three manners:

(1) Name is a word consisting of a plurality of characters. As the characters, an upper-case letter, numbers, and lower-case letters may be used.

(Ex.) Nef, p53, Akt, Vav, Rap1

(2) Name consists of multiple words including upper-case letters, numbers, and lower-case letters.

(Ex.) mitogen-activated protein kinase (MAPK), interleukin 2 (IL-2)-responsive kinase

(3) Name is a word consisting entirely of lower-case letters.

(Ex.) actin, pepsin, insulin

Because the naming manners (1) and (2) are peculiar to proteins, it is relatively easy to predict protein names categorized under these naming manners. However, because the naming manner (3) in which a name-word consists entirely of lower-case letters, it is hard to predict protein names categorized under it. It can be said that protein names categorized under (3) tend to end with -in, -aze, -ol, -some, -polymer, -dimer, -trimer, etc. However, it is possible to pick up a word other than protein names, based on this definition. The exemplified enzyme names are traditionally called so, though not in accordance with the naming rule of proteins, and such names are rather rare and thought not to increase much in future. Thus, such protein names that are hard to predict should be registered by biologist preferentially and excluded from prediction process; that is, extract them using only the dictionary.

Many synonyms of protein names exist and different paper authors use different synonyms to express a protein. Protein name variants are exemplified below.

(1) Abbreviation and change between upper-case and lower-case letters

(Ex.) epidermal growth factor receptor|EGF receptor|EGFR poly(ADP-ribose)polymerase|poly(ADP-Ribose)polymerase|PARP c-Fos|c-fos|c fos

(2) Explanatory name that designates the role of the protein (authors may use different wording to explain the same function.)

(Ex.) the Ras guanine nucleotide exchange factor Sos the Ras guanine nucleotide releasing protein Sos the Ras exchanger Sos the GDP-GTP exchange factor Sos Sos (mSos), a GDP/GTP exchange protein for Ras

(3) Name including a preposition and connection (rather complex modification relationship)

(Ex.) p85 alpha subunit of PI 3-kinase poly (C) and poly (U) homopolymer SH2 and SH3 domains of Src

Although a wide range of protein name variants are used, significant keywords are found in most of protein names. For example, in a string “c-Jun NH2-terminal kinase (JNK) and p38”, “c-Jun”, “NH2”, and “p38” are keywords. Such significant keywords including abbreviated protein names are referred to as main keywords herein. Some compound word name includes a keyword as a general term designating the function and property of the protein. Examples of such general term are “receptor” in a string “IL-4 receptor” and “protein” in a string “CREB binding protein” This general term is referred to as a function keyword of a protein name herein. In prediction algorithm which will be described later, these keywords are looked for so that protein name candidates including those that are added in anticipation of finding in future will easily be found.

1.2 Semi-automatic Construction of a Protein Dictionary

Through consideration of the above-described protein naming manners, an efficient way of constructing a dictionary by biologists is to register main keywords first of all. Then, register single words of protein names consisting entirely of lower-case letters, which are virtually impossible to predict, into the dictionary.

Another way of constructing the dictionary is to automatically register protein names retrieved from public databases (step 102 in FIG. 1). Protein names and synonyms that the databases cannot supply should be registered by biologists.

In the following illustrative procedure of dictionary construction, protein names, synonyms, and cross-reference information (information indicating entries interlinked across the databases) are extracted from three databases, namely, SWISSPROT, PIR, and CSNDB and integrated into the protein dictionary.

(1) Retrieve a protein name (official name in each database) and its synonyms from each database and put them into one associative group.

(2) Search for the same protein name across all databases and combine the same ones.

(3) Identify the same protein from cross-reference information and combine the same ones.

In the following, the method of extraction from each database will be detailed.

1) SWISSPROT

In the SWISSPROT database, protein names are described in the following form:

DE Official-name (Synonym1) (Synonym2) . . .

First, retrieve the official name and synonyms from the DE (description) fields of each record in the database as protein names.

Because the protein names in the SWISSPROT are described in all upper-case letters, then, convert the upper-case letters to low-case letters by comparing with the corresponding words in other databases. Do not make this conversion for words that do not exist in other databases because conversion to lower-case letters without reference may make it impossible to discriminate between a word and an abbreviation. Output such words as candidates for upper-case to lower-case letter conversion and biologists will determine whether to register them into the dictionary.

By name notation in the SWISSPROT, expression to be separated exists, such as “name and abbreviation” in a string “ESTROGEN RECEPTOR ER”. Thus, taking that into consideration, register words into the dictionary. Specifically, a name consisting of five or less characters is regarded as abbreviation. Check if there is a word consisting of the initial letters of abbreviation preceding or following another word. If so, the word must be registered as an abbreviation.

2) PIR

In the PIR database, protein names are described in the following form:

ALTER_NAME Synonym1; Synonym2 . . . Synonym (n)

Retrieve the synonyms from the ALTER_NAME fields as protein names.

3) CSNDB (Cell Signaling Networks Database)

In the CSNDB, protein names are described in the following form:

| | |
|---|---|
| Signal_Molecule | Official Name |
| Other_Name | Synonym1 |
| Other_Name | Synonym2 |
| Type | Types |

Because some entries in the CSNDB are not proteins, if the type field of a record contains Cytokine, Enzyme, Transcription_Factor, Receptor, Effector, or Ion_Channel, retrieve the entry name (Signal_Molecule) and synonyms (Other_Names) as protein names.

Meanwhile, in some fields in the SWISSPROT, an entry like the one given below exists to give cross-reference information:

DR PIR; B26342; B26342.

This indicates that information related to the target protein exists at B26342 of PIR. Such reference information is cross linked across the databases. When a protein is identified, cross-reference information is be referred to. For example, when different synonyms of one protein name are registered in three databases, respectively, the referenced protein name and the synonyms registered in the databases are combined into one record and automatically registered into the dictionary. From cross-reference information, three-dimensional structure, sequence, function, sequence of genes, etc. can be obtained. When extending the dictionary and database search in future, it will be possible to build a more accurate dictionary, using cross-reference information.

A substance name record in a form that an official name is followed by its synonyms is stored into the dictionary. However, there is a possibility of information in error being stored in the protein dictionary that has automatically been built from the public databases. Therefore, biologists are to check the dictionary contents, correct an error if exists, and update the dictionary.

A part of the dictionary constructed through the above procedure is exemplified below:

PROTEIN NAMES

| | |
|---|---|
| #Protein name | ESTROGEN RECEPTOR |
| #Synonyms<SPROT> | ER |
| (Alternate names<PIR>) | ESTRADIOL RECEPTOR R-ALPHA |
| #Gene type<SPROT> | ESR1 NR3A1 ESR |
| #Organism<PIR><SPROT> | Homo sapiens (Human) TaxID:9606 |
| #EC Number<PIR><PDB> | None |
| #Keywords<SPROT><PIR> | Receptor; Transcription regulation; |
| | DNA-binding . . . |

1.3 Extracting Protein Names Using the Dictionary

Based on the protein names registered in the dictionary, extract protein names from literature (step 103 in FIG. 1). From target literature, extract words, each completely matching the official name of a protein or one of its synonyms registered in the dictionary, and output the thus extracted protein names in a table form.

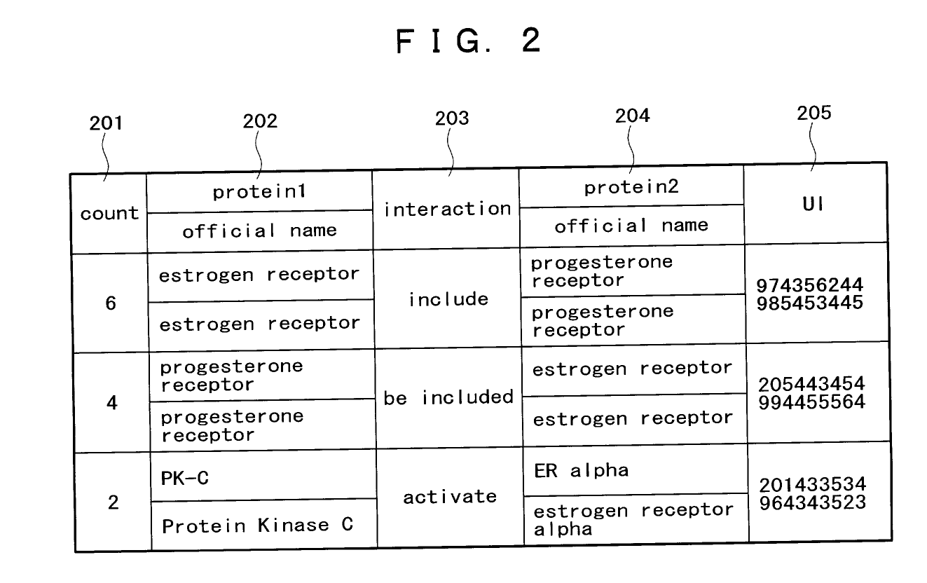

FIG. 2 illustrates an exemplary output table. The table shown in FIG. 2 lists the results of extracting substances names and relations (binary relations) between substances, containing counts (201) indicating the number of times the relevant substances appeared in the literature, two protein names and official names (202, 204), keywords (203) indicating binary relations between two substances, and literature numbers (205).

1.4 Extracting Protein Names by Prediction

Algorithm for predicting protein names and extracting them from text (step 104 in FIG. 1) will be explained below.

In the present invention, the following are extracted as “target”

Protein names (including kinase, receptor, ligand, enzyme, and compound)

Domain name, motif, site, fragment, element, etc. of a protein

Protein names are extracted in the following three phases.

[1] Extract main keywords and function keywords from token-segmented text (refer to the paragraph below). (See Section 1.4.1.)

[2] Combine main keywords and function keywords. (See Section 1.4.2.)

(a) Build a noun phrase of main keywords without a connection and preposition.

(b) Build modification relationships.

(c) Erase unnecessary annotations.

[3] Correct prediction errors. (See Section 1.4.3.)

In the above, “token” is character strings that constitute the minimum semantic unit and text divided into token units is referred to as token-segmented text. Uncorrectable errors in phase [3] are output as error candidates so that biologists can see those presented via a GUI (Graphical User Interface). The biologists can select any of the error candidates presented, specify the official name of a protein and synonyms, and register them into the dictionary.

Process in each phase of extracting substance names by prediction will be detailed below.

1.4.1 Extracting Main Keywords and Function Keywords

In the first phase of prediction, extract main keywords and function keywords from token-segmented text. Extract main keywords, using algorithm that will be described in the following paragraph. Extract function keywords included in a list of function words that has been created beforehand because the function words are not so many. Words are extracted in this phase and then combined as will be described in Section 1. 4. 2, and eventually, sentences are output as the results of extraction.

Algorithm for Extracting Main Keywords

(1) Extract all words that can be regarded as main keywords candidates including upper-case letters, numbers, and special characters (particularly, “-”).

(2) Remove words extracted from sentences matching a cited references notation pattern from the main keywords candidates. This is because cited references noted are thought to include many upper-case letters of titles, person names, etc. Cited references notation patterns are to be created beforehand.

(3) Remove words consisting entirely of lower-case letters preceding or following “-” from the main keywords candidates. This is because such words are mostly general words and most protein names consist of mixed lower-case, upper-case letters, and numbers.

(4) Remove words that are plainly judged general words (such as abbreviation and units) from the main keywords candidates. Create a list of such words beforehand and remove words included in the list. Examples of these words are “Mr.”, “UV”, and “Mbps”

In the way described above, main keywords and function keywords can be extracted. After thus extracting main keywords and function keywords, combine the keywords while reviewing the sentences including the extracted words.

1.4.2 Combining Main Keywords and Function Keywords

In order to combine the keywords, combine main keywords into annotation in a sentence including the main keywords extracted by the algorithm described in Section 1.4.1. Annotation is extended to adjacent words and other compound words as annotations, taking modification relationship into consideration. Thereby, a noun phrase without a connection and preposition is created. In the following methods, combine main keywords into a main keyword group and then extend annotation across main keyword groups, taking modification relationship into consideration. Annotation is enclosed by brackets ([ ])

Building a Main Keyword Group

(1) Method of building a main keyword group, using only superficial clues

(a) Simply combine adjacent main keywords and function keywords into annotation.

(Ex.) [p38] MAP [kinase]→[p38 MAP kinase]

(b) Convert a word or words enclosed by parentheses like the ones exemplified below to annotation.

(Ex.) ([CD45])→[(CD45)], ([MMP-2] (and|or) [MMP-9])→[(MMP-2 (and|or) MMP-9)]

(2) Method of building a main keyword group by parsing a sentence into parts of speech

(a) Combine non-adjacent annotations and words therebetween if the words are nouns, adjectives, or numerals.

(Ex.) [Ras] guanine nucleotide exchange [factor Sos]→[Ras guanine nucleotide exchange factor Sos]

(b) If definitives and/or a preposition precede an annotation word, extend the annotation to include the preceding words.

(Ex.) the growth hormone secretagogue [receptor] ([GHS-R])→the [growth hormone secretagogue receptor] (GHS-R)]

(c) If a Greek alphabet or its spelled-out word follows an annotation word, extend the annotation to include the following word.

(Ex.) [p53] alpha→[p53 alpha], [INF] gamma→[INF gamma]

Building Modification Relationships

Built modification relationships across substance names as annotations, according to the following patterns:

(1) [A], [B], [ . . . ], [C] and [D] [function word]→[A, B, . . . , C and D function keyword]

(2) [A, B, . . . , C] and [D] of [E]→[A, B, . . . , C and D of E]

(3) [A] of [B], [C] and [D]→[A of B, C, and D]

(4) [A function keyword main keyword] and [main keyword]→[A function keyword main keyword and main keyword]

(5) [A] of [B]→[A of B]

(6) [A], [B]→[A, B]

where main keywords and function keywords are those noted above herein and A, B, C, D, and E are extracted words that have already been marked as annotations.

Erasing Unnecessary Annotations

Furthermore, rectify incorrect annotations by applying two rules. The first rule is applied to single function keywords marked as annotations, but remaining as is without being extended. Remove such keywords to avoid very ordinary function keywords. The second rule is applied to a phrase created by extending compound words, ending with a word that is not a noun. This occurs because a main keyword is not always a noun. An example of such word is “Jun-related”. By applying two rules based on pattern matching using normalized expressions, some annotations are removed or shifted.

1.4.3 Correcting Prediction Errors

Most targets extracted in the manner described in Sections 1.4.1 and 1.4.2 include a main keyword or function keyword. However, there is a possibility of errors being included in the extracted targets; such as non-protein names or annotations of incorrect modification relationship. This section describes how to correct such prediction errors. Uncorrectable errors are output as error candidates so that biologists will determine whether they are protein names later via GUI (Graphical User Interface). If an error candidate is a protein name, it is registered into the dictionary without being corrected via the GUI (step 105 in FIG. 1). Prediction errors are output as error candidates and, however, if an error candidate is a protein name, it is registered into the dictionary. Thereafter, it will not be output as an prediction error candidate.

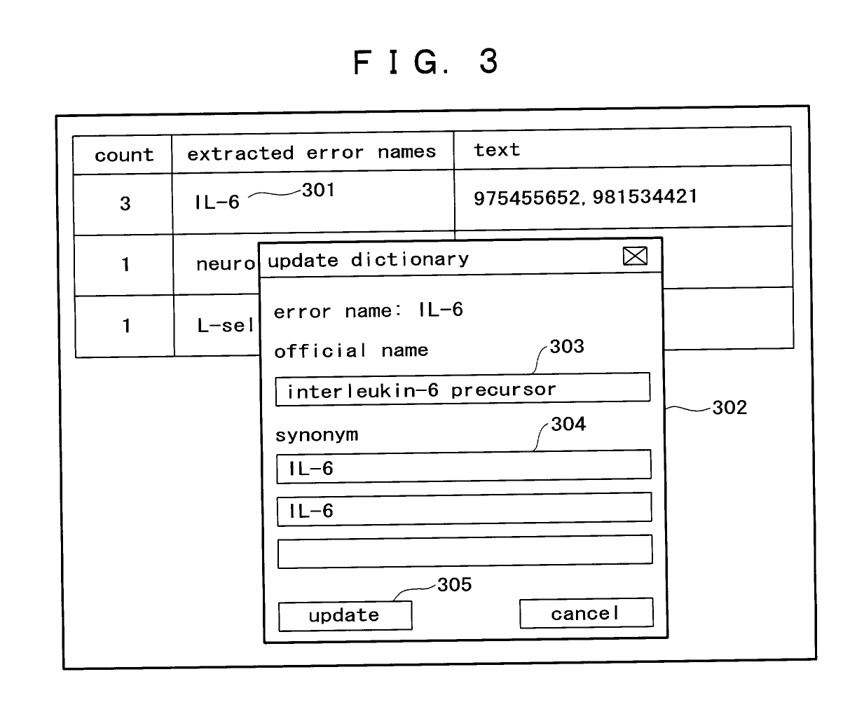

FIG. 3 illustrates an example of registering a protein name that has been output as an error candidate into the dictionary. FIG. 3 shows a table listing error candidates, one of which is selected by a biologist and registered into the dictionary. When one error candidate 301 is selected, a dialog box 302 for entering information to be registered into the dictionary appears. By entering the official name of the protein into its entry box 303 and synonyms into the synonym entry boxes 304 and clicking the update button 305, the new protein name and synonyms can be registered into the dictionary.

Protein names that are not extracted in the manner described in Sections 1.4.1 and 1.4.2, such as “insulin”, “adenylyl cyclase”, and “pepsin”, are extracted, using only the dictionary; prediction does not apply to them, considering that proteins of this kind are not so many and a small number of future findings of this kind of protein is anticipated as described in Section 1.1.

Types of words that may be erroneously extracted will be enumerated below with methods of error correction for each type.

(1) Improper annotation

(a) Non-protein name

(Ex.) TCP (abbreviation of “Transmission Control Protocol”)

This error occurs because the prediction algorithm regards such abbreviation consisting of upper-case letters as an abbreviated protein name. For abbreviation of a protein name, its full name often appears in the earlier part of literature. Thus, look for its full name in the list of compound words found before the abbreviation. If the full name exists, the abbreviation is regarded as a protein name. If not, the abbreviation is output as an error candidate to be judged by a biologist later. If it is a protein name, its name is registered into the dictionary.

(b) Substance name not removed from the targets during the algorithm process

(Ex.) PC6 cell, filamentous bacteriophage fuse4

Because such name is a cell name or virus name in most cases, look for a word designating it around a target word and remove that word ((Ex.) “in” and “cell” in “ . . . in PC cell”).

(2) Error due to incorrect keyword combination and extension of annotation

(a) Insufficient extension

(Ex.) interleukin [4 (IL-4)-responsive kinase] (*Annotation must include interleukin.)

In this case, because the annotation includes a keyword designating a protein name, it is extracted as a protein name. Thereafter, by judgment of a biologist, a word preceding or following the annotation should be registered into the dictionary.

(b) Verbose annotation extension

(Ex.) the [same proline-rich region of FAK (APPKPSR)] (*Annotation must not include “same” that is a general word.)

List general words that may be used to modify a substance name beforehand and exclude such words from extension.

2 Extracting Binary Relations between Substances from Text Databases and Numerical Expression of Relations

This section describes a method of searching out binary relations between substances, based on literature written in natural language and stored in public databases, and assigning a significance value to each extracted binary relation, based on any criterion, to help users to narrow down the search range to find a relation between substances of interest.

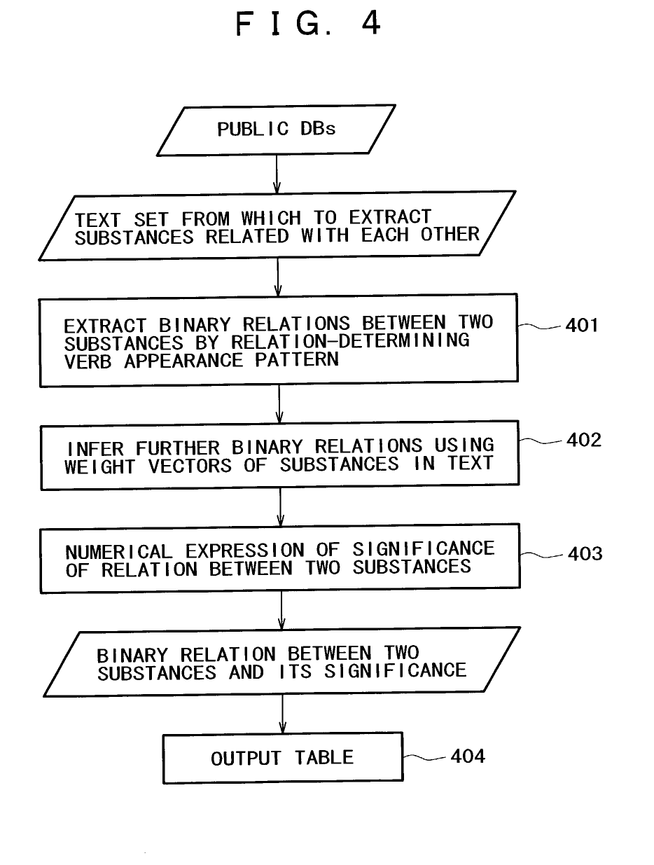

FIG. 4 shows a flowchart explaining an overall process flow for implementing the above method. First, extract binary relations between substances by relation-determining verb appearance pattern (step 401). Search for those screened out by pattern matching by inferring further binary relations between substances, using weight vectors of substances in text (step 402). For the thus extracted binary relations, obtain a numerical value of significance of a relation between two substances (step 403). The significance value is presented in step 404 so that users will narrow down the spectrum of binary relations between substances of interest, using the presented value.

2.1 Extracting Binary Relations between Substances

To extract binary relations, automatons based on sentence patterns including a word that determines such relation are used. However, all possible sentence structures of human-written text cannot be classified into simple patterns and it is thought that many binary relations between substances are screened out in the process using automatons. Therefore, another method for inferring whether further binary relations between substances exist in text is used together with the automaton method.

2.1.1 Extracting Binary Relations between Substances by Relation-Determining Verb Appearance Pattern

(1) Relational Verb

The first step of extracting binary relations between substances by relation-determining verb appearance pattern is finding words that are often used to determine such relation. These words are referred to as relation verbs in the present invention. Table 1 shown below lists exemplary verbs expressing interaction between two proteins or genes. Collect such relational verbs by analyzing text from public databases manually or using a computer. Knowledge of such verbs can also be obtained from biologists in technical fields in which extracting binary relations between substances is necessary.

TABLE 1
Exemplary relation-determining verbs

| | | | |
|---|---|---|---|
| “act” | “affect” | “activate” | “associate” |
| “become” | “bind” | “block” | “break down” |
| “catalyse” | “cleave” | “coelute” | “complex” |
| “combine” | “complex” | “conjugate” | “connect” |
| “control” | “cooperate” | “corporate with” | “create” |
| “degrade” | “dissolve” | “donate” | “export” |
| “hydrolyze” | “induce” | “inhibit” | “integrate” |
| “interact” | “interfere” | “intermediate” | “mediate” |
| “metabolize” | “modify” | “modulate” | “phosphorylate” |
| “react” | “regulate” | “release” | “serve” |
| “stimulate” | “suppress” | “tie” | “transport” |

Furthermore, users can map importance in a hierarchical structure of ontologies concerning these verbs. Importance mapped is used when significance values of binary relations will be assigned later and the significance values help the user to find a binary relation that the user takes it as important.

(2) Relation Template Automatons

After collecting relational verbs that express interaction between substances, then, analyze a sentence including a relational verb, not a single word, to categorize it as a sentence pattern. Through this analysis for all extracted sentences, obtain all possible patterns, for example, patterns such as “(substance name 1) activates (substance name 2)” and “(substance name 1) interacts with (substance name 2).” The possible sentence patterns include inflection of a verb in the passive voice and the progressive form, the noun form of a verb such as “interaction of (substance name 1) with (substance name 2.” and combination of a verb with a preposition. Prepare such sentence patterns as automatons in the system. Such automatons are referred to as relation template automatons herein. Although, naturally, collecting these sentence patterns is carried out by biologists, automatic collection thereof is desirable, considering that binary relations between substances are extracted from latest large-scale databases. In this embodiment of the present invention, automatic collection of sentence patterns is performed by applying DIPRE (Dual Interactive Pattern Expansion) algorithm of brin that is an approach to automatically extracting information from HTML text.

DIPRE Algorithm

The DIPRE algorithm is intended to extract a couple of words having some meaning (for example, (author and the title of an article), (university and its location), etc.) from HTML text. To briefly explain, this algorithm repeats the following two processes:

1. Based on a given couple of words, extract a sentence describing relation between the words from text. This is carried out by extracting a sentence including the two words that are relatively near to each other.

2. Based on a given sentence describing relation between words, extract a couple of words. This is carried out by searching out a sentence of the same form as the given sentence from text.

By applying this algorithm to text about molecular biology, sentence patterns are automatically collected. For example, if the purpose of extracting binary relations between substances is to obtain interaction between genes, extracting a couple of (gene name and gene name) and extracting sentences describing interaction between genes, such as “(gene name) be located with (gene name),” “(gene name) assembles (gene name),” and “(˜combine (gene name) and (gene name)” are performed alternately.

(3) Extracting Binary Relations

Depending on whether a relation template automaton accepts a sentence in text from which to extract binary relations, whether a relation between two substances exists in the sentence can be found.

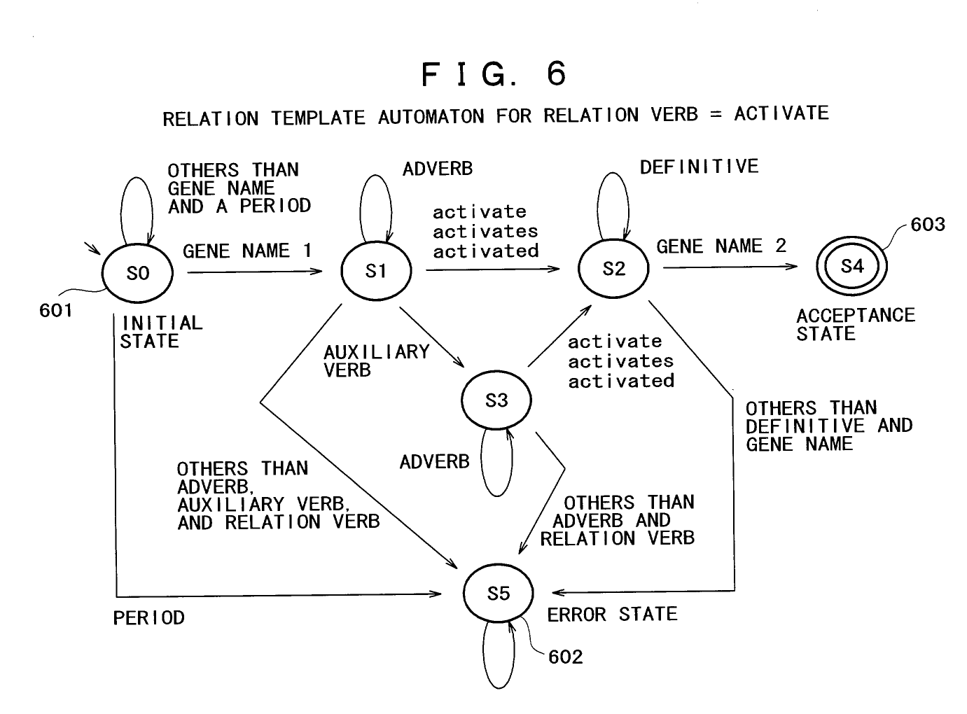

FIG. 6 illustrates an exemplary relational template automaton concerning a verb “activate” that defines the relation between two genes. As indicated by reference numeral 601, the initial state is represented by a circle with an arrow at its upper left. When the automaton receives a gene name in the initial state S0, transition to the next state S1 occurs. As indicated by a loop above the S0 state, the initial state remains as is until the gene name appears in the sentence. If a period comes, it is regarded as an error because it is the end of the sentence. Transition to the error state S5 that indicates that the automaton has not accepted the sentence occurs and the process terminates. When the process is executed and comes to the reception state S4 603, it can be determined that the sentence expresses a relation between the genes.

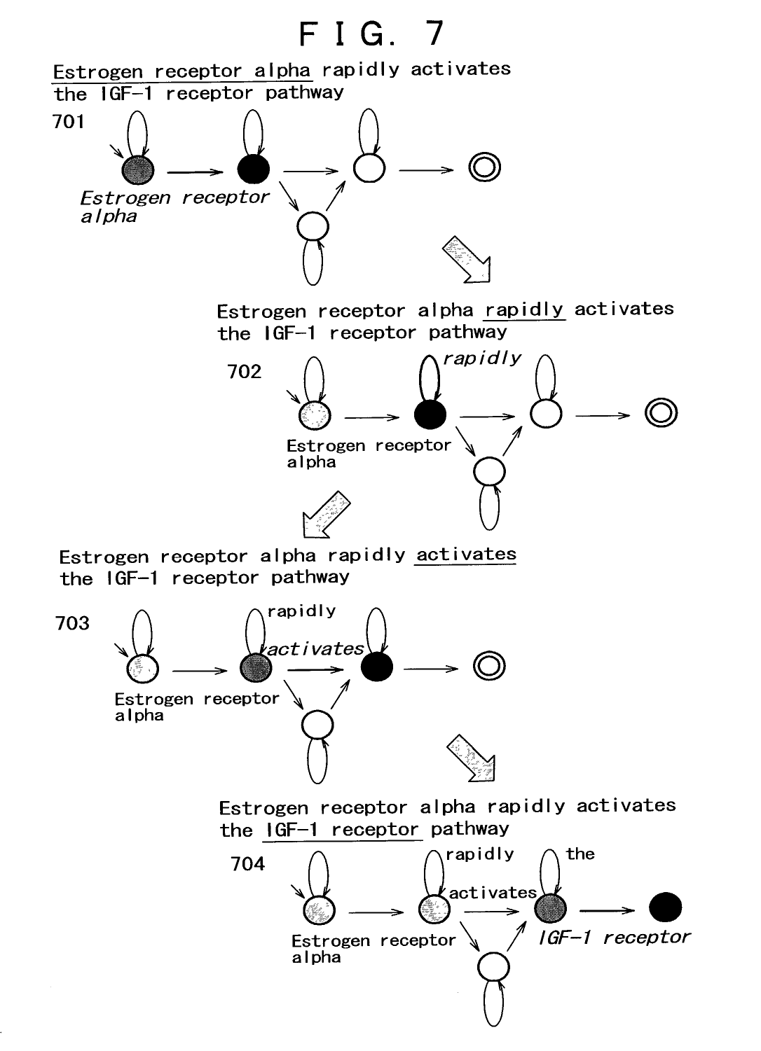

As an example, FIG. 7 illustrates how a sentence “Estrogen receptor alpha rapidly activates the IGF-1 receptor pathway.” is accepted by an relational template automaton. However, the error state is omitted. In a first phase 701, the automaton receives gene name “Estrogen receptor alpha” and transition from the initial state S0 to state S1 occurs. As shown in a second phase 702, because the next word “rapidly” is adverb, the state remains unchanged. In a third phase 703, a relation verb “activates” comes and causes transition to state S2. The next word “the” is processed, which is not shown. However, because this word is definitive, the state S2 remains as is as apparent from in FIG. 6. In a fourth phase 704, a second gene name “IGF-1 receptor” comes and changes the state to the acceptance state, and the relation between the two genes has now be found out.

2.1.2 Inferring Further Binary Relations Using Weight Vectors of Substances in Text

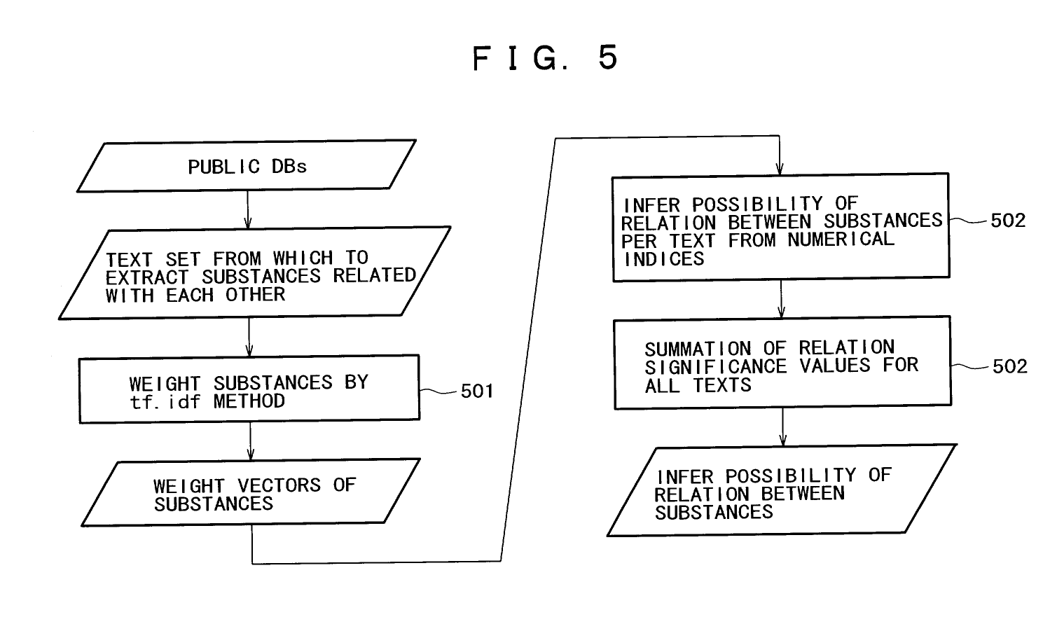

The outline of this process is now explained, using FIG. 5. First, retrieve a text set from public databases such as MEDLINE. From this text set, binary relations are extracted and their significance values are assigned. At the same time, construct a dictionary of substance names for which to extract binary relations between two substances. Then, convert the plain text form of the text retrieved from the databases to text including weight vectors by using method tf.idf (step 501). The vector elements correspond to the substance names in the dictionary. From the number of times a substance name appears in the text and its distribution throughout the text, the importance of the substance in the text set is determined. Using the weight vectors of the substances, infer whether any relation exists between two substances (steps 502, 503). In this way, binary relations between substances are extracted, using the weight vectors of the substances in text, and their significance values are assigned. In the following, the step 501 will be detailed in Subsection (1) and the steps 502 and 503 will be detained in Subsection (2).

(1) Converting Text to Text Including Weight Vectors

In this embodiment of the present invention, text dᵢ is converted to text including weight vectors Wᵢ, based on the tf.idf method. The tf. idf method is as follows.

tf. idf Method

The tf.idf method is a method of calculating the importance of a target word of search in text, using two indices: TF that indicates how many times the target word appears in the text and IDF that indicates how typically the target word is used in the database. After search, importance W (d, t) of a target word is expressed by the following equation:

W (d, t)=TF (d, t)×IDF (t)

where

TF (d, t): frequency of appearance of the target word t in text d

IDF (t): log (DB (db)/f (t, db))

DB (db): the number of all texts in a database db

f (t, db): the number of texts that include the target word t among the texts stored in the database db

Based on the above equation, obtain Wᵢ (t), using the following equation:

Wᵢ (t)=Tᵢ (t)×log (N/f (t, T))

where

Tᵢ (t): frequency of appearance of a protein name or gene name t in text d₁

N: the number of texts in a text set

f (t, T): the number of texts including t in the text set T

Evaluate the above equation for all substance names registered in the dictionary and obtain weight vector W₁ (t).

Unlike weighting by simple frequency of appearance, weighting that incorporates relative importance of a substance can be obtained by using the tf.idf method. The higher the frequency of appearance of t in text dᵢ, the greater will be its weight. However, the greater the number of texts including t, t is regarded as general and its relative importance decreases, which reduces its weight adversely.

When the weight vectors of the substances in a document text are obtained, information about where the substance names have been found in the document text is also recorded. This information is used to estimate relation between two substances, which will be described in Subsection (2) that follows. A number consisting of nine digits is used to locate a substance name in the document text; two digits to specify a chapter, two digits to specify a section, two digits to specify a paragraph, and three digits to specify a line. For example, number 020104031 indicates that the substance name has been found on line 31 in paragraph 3, section 1, chapter 2. For substance names t appearing in each text, the numbers indicating where they have been found are listed and stored.

(2) Inferring Whether Any Relation Exists between Two Substances

After converting text to text including weight vectors, infer whether any relation exists between two substances t₁ and t₂, using EX (t₁, t₂) as the index of possibility of binary relation between them, based on the obtained weight vectors of the substances.

$$EX ( {t}_{1} , {t}_{2} ) = {\sum }_{i}^{N} {W}_{i} ( {t}_{1} ) \times {W}_{i} ( {t}_{2} ) \times PR ( {t}_{1} , {t}_{2} , i ) \\ \begin{matrix}PR ( {t}_{1} , {t}_{2} , i ) = \frac{999}{min ( \vert {p}_{i} ( {t}_{1} ) - {p}_{i} ( {t}_{2} ) \vert )} & if {p}_{i} ( {t}_{1} ) - {p}_{i} ( {t}_{2} ) \neq 0 \\ PR ( {t}_{1} , {t}_{2} , i ) = 1000 & if {p}_{i} ( {t}_{1} ) - {p}_{i} ( {t}_{2} ) = 0\end{matrix} \qquad [ Equation 1 ]$$

where pᵢ(t): location where t appears in text dᵢ obtained and recorded in (1)

Wi (t) indicates the importance of one substance, whereas PR (t₁, t₂, i) is considered to as indication of the importance of a pair of substances t₁ and t₂ in one document text. The denomination of the right-hand member of PR (t₁, t₂, i) expresses the positions of a couple of t₁ and t₂ that are the nearest to each other among all couples of t₁ and t₂ appearing in text di. Because the numerator is 999, when the dominator is 1000 or greater, that is, t₁ and t₂ do not exist in one paragraph, PR (t₁, t₂, i) decreases. Inversely, the nearer to each other the positions of t₁ and t₂ in one paragraph, PR (t₁, t₂, i) increases. By summing up the values of PR (t₁, t₂, i) obtained for all document texts, the index is obtained by which to infer whether any relation exists between t₁ and t₂. Users can specify a threshold of this index value as a criterion so that the computer determines whether binary relation between two substances exist, according to the threshold. When the resultant index value indicates high possibility of such relation existing, the computer presents the sentence that probably describes the relation between the substances to the user, using the location information.

2.2 Assigning Numerical Significance Values to Binary Relations and Usage Thereof

For the thus searched out binary relations between substances, obtain their “significance values,” based on further indices. Using the significant values, users can narrow down of the spectrum of binary relations of interest.

2.2.1 Assigning Numerical Significance Value to Binary Relations

(1) Count the sentences found to describe a binary relation between substances by analysis and calculate significance index GGR (t₁, t₂, r), based on the count, where t₁ and t₂ are substance names and r is a relation.

$$GGR ( {t}_{1} , {t}_{2} , r ) = {\sum }_{k = 1}^{M} {p}_{k} \times R ( r ) \qquad [ Equation 2 ]$$

where

Pₖ=1 when relation r has been found in a sentence k

Pₖ=0 when relation r has not been found in a sentence k

R (r): importance mapped to r in the hierarchical structure of relational verb ontologies

(b) The more the sentences describing the binary relation between substances in one document text and the more the texts including such sentences, the significance of the relation is considered greater. Based on this reasoning, calculate significance index RTF (t₁, t₂, r) as is defined below:

$$RTF ( {t}_{1} , {t}_{2} , r ) = {\sum }_{n = 1}^{∞} n \times TT ( {t}_{1} , {t}_{2} , r , n ) \times R ( r ) \qquad [ Equation 3 ]$$

where

n: the number of sentences describing the relation r between substances t₁ and t₂ in one document text

TT (t₁, t₂, r, n): the number of texts including n sentences describing the relation r between substances t₁ and t₂

R(r): the value as described in (a)

(c) Index RF (t₁, t₂, r) using the tf.idf method

RF (t₁, t₂, r)=GGR (t₁, t₂, r)×IDF (t₁, t₂, r)

where

GGR (t₁, t₂, r): the index as described in (a)

IDF (t₁, t₂, r): log (DB(db)/f (t₁, t₂, r, db))

DB (db): the number of all texts in a database db

f (t₁, t₂, r, db) : the number of texts including sentence describing the relation r between t₁ and t₂ among the texts stored in the database db.

2.2.2 Usage of Binary Relation Significance Values

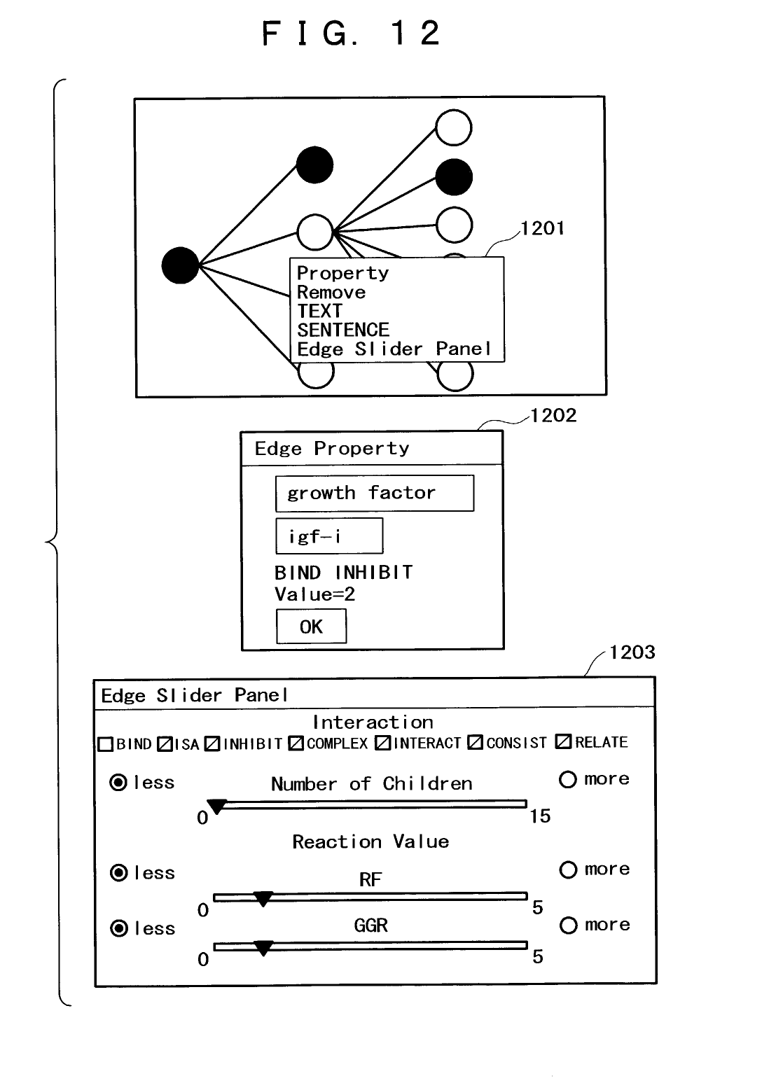

A viewer for displaying binary relations between substances will be detailed in Section 3 Visually Presenting Binary Relations. This section briefly describes how the thus obtained binary relation significance values are used, using FIG. 12.

FIG. 12 illustrates exemplary visual presentation of binary relations between substances, wherein nodes of white or black circles are shown; one node corresponds to any substance and a line (edge) between two nodes corresponds to a relation between two substances. Using an interface named an Edge Slider Panel, which is depicted in the lowest part of the page of FIG. 12, the user can change the binary relations in different views. The panel includes the checkboxes for binary relation types under label “Interaction.” It is advisable to check only the checkboxes for the relation types for which the user wants to get information, and the user can make the edges corresponding to deselected relation types hidden.

The panel also includes slider bars corresponding to relation significance index values such as RF (t₁, t₂, r) and GGR (t₁, t₂, r). Using the slider bars, the user can assign the thresholds of these significance values. Only the relations of higher or lower significance value than the assigned thresholds are shown. In addition to the tree graph form of binary relations shown in FIG. 12, two substance names and a relation verb connecting them in a set and a sentence in which they appear can also be shown. Furthermore, original text can be shown, including keywords in which links are embedded and the user can view the information linked with a word by clicking the word. For details on these functions will be described later.

3 Visually Presenting Binary Relations

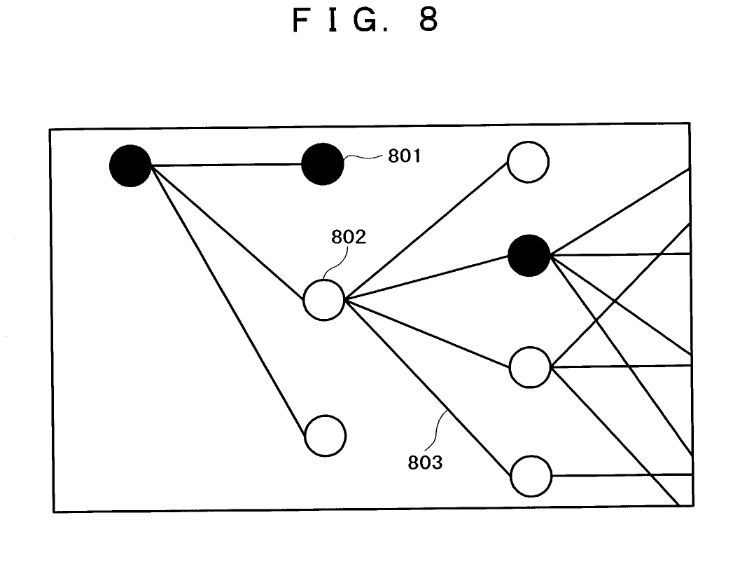

This section describes a dynamic viewer that reads binary relations between substances and graphically presents the pathways of the relations, allowing for editing. A dynamic viewer is provided, according to the present invention. The dynamic viewer reads data of binary relations between substances, for example, the data shown in FIG. 2, connects the substances related with each other by a line from individual data, and visually presents the binary relations as is shown in FIG. 8 by applying the connection algorithm recurrently to all couples of substances. As shown in FIG. 8, the viewer makes substance types distinguishable by using different colors of nodes like nodes 801 and 802 and connects two nodes of substances with an edge (line) 803.

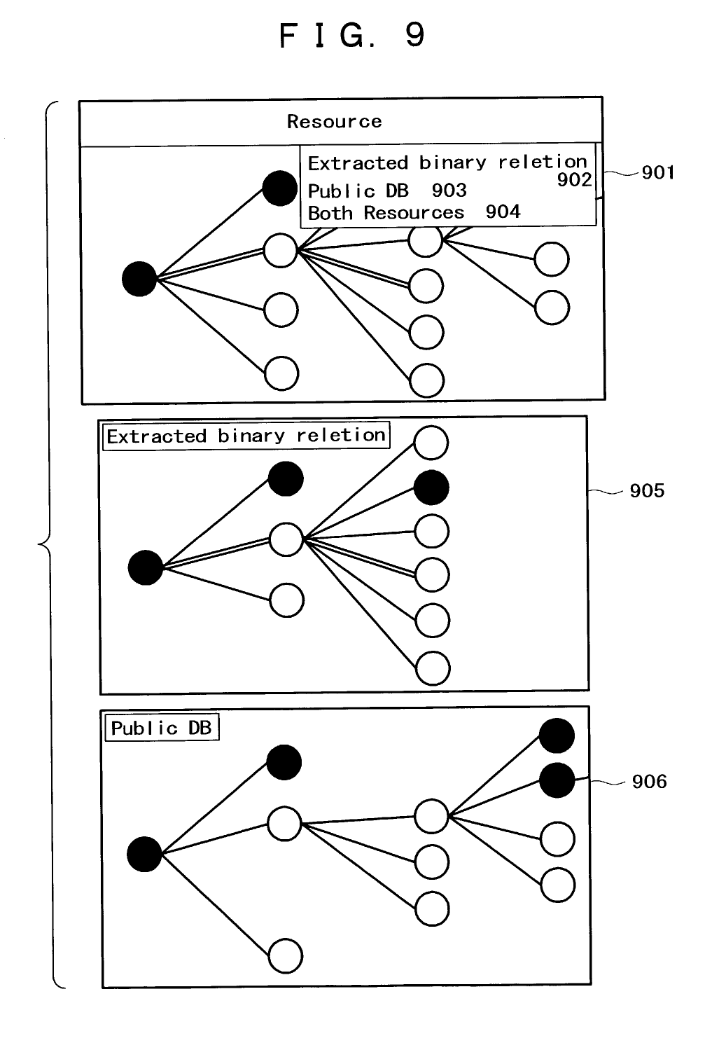

The dynamic viewer allows the user to freely change the resources from which the binary relations are presented and dynamically presents the binary relations arranged in a visual topology, according to change. This appearance is shown in FIG. 9. As shown in the view at the top in FIG. 9, the view includes a resource selection menu of the items: extracted binary relation 902 extracted by the above-described methodology of the invention; pubic DB 903, binary relations automatically extracted from public databases in which information on substances and binary relations is stored; and both resources 904, binary relations extracted from both resources as the binary relations to be presented. The user can select any resource from the menu. That is, the viewer can display only the information for the binary relations that the user get or only such information from public databases, though the user does not get it, or simultaneously display those from both resources. On the viewer 901 shown at the top, the binary relations extracted from both resources are displayed on the assumption that both resource 904 has been selected from the resource selection menu. According to the resource selection from the menu, the viewer output dynamically changes to the viewer 905 at the middle (when extracted binary relation 902 has been selected) and the viewer 906 at the bottom (when public DB 903 has been selected). The dynamic viewer is implemented in Java and runs as an applet and locally.

3.1 Functional Overview of the Viewer

First, functional overview of the dynamic viewer of the present invention will be described below.

3.1.1 Layout Views

The viewer is capable of visually presenting binary relations between nodes (elements data for which binary relations are visualized) in different modes of layout views. When the server finds out new information, layout is dynamically changed in the layout views. Examples of the layout views (hereinafter referred to as views) will be explained below.

(1) Simple

The viewer creates a systematic tree of binary relations, which branches from the left to the right, according to the development of the binary relations develops.

(2) List

The viewer shows the binary relations listed from the left. The more distance (depth) from a principal node, the nodes and relation therebetween are positioned to the right.

(3) Explorer

The viewer shows nodes as folders as a common explorer does. According to the number of children, the nodes are automatically sorted and shown. The “children” means nodes having a binary relation with a node and are arranged on a hierarchy just under the node. Children evolving from one of the children from the node and children evolving from one of them may be called ground children and descendants. When a node is double clicked in the “Simple” or “List” view, the viewer hides all ground children and descendants of the node, but normally shows only its children. To make the viewer show all ground children and descendants, select “Show Children” from a pop-up menu.

(4) Animate

The viewer renders animation layout, using the binary relations. It fixes a node on which the focus is placed, keeping the distance between nodes constant.

3.2 Details on the Layout Views

In the layout views, the viewer can visually present binary relations data in different modes. The following subsections fully describe the layout views.

3.2.1 Simple

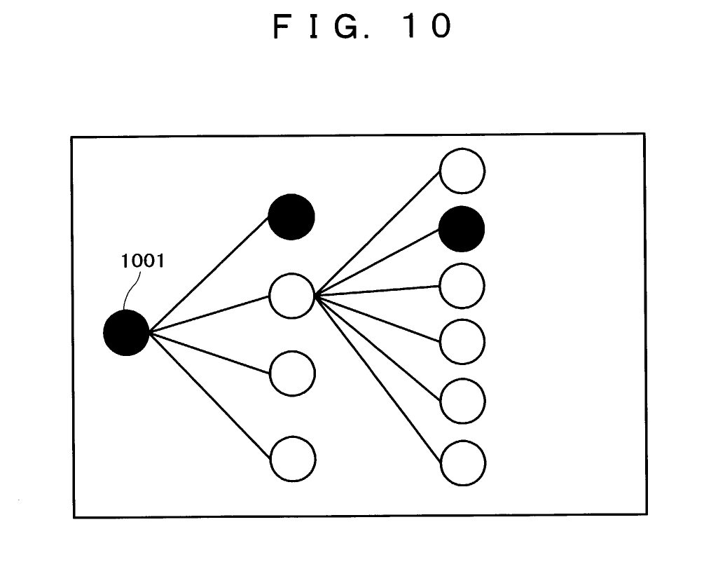

The viewer creates a systematic tree of binary relations, which branches from the left to the right, according to the development of the binary relations develops. The thus displayed nodes can be dragged or with a mouse. When you drag a node, its edge (binary relation between the node and another node) moves accordingly. When you select “Start” from the “File” menu, the viewer resets the layout and shows another layout. FIG. 10 shows a simple view example (from the origin node 1001, edges spreads in a sector form. The nodes are shown in different colors by type. The following operations can be performed.

(1) Switching between showing and hiding children

By double-clicking a node, switching between showing and hiding the nodes having a binary relation with that node on the deeper hierarchy (the nodes arranged on the right sides) can be done.

(2) Node

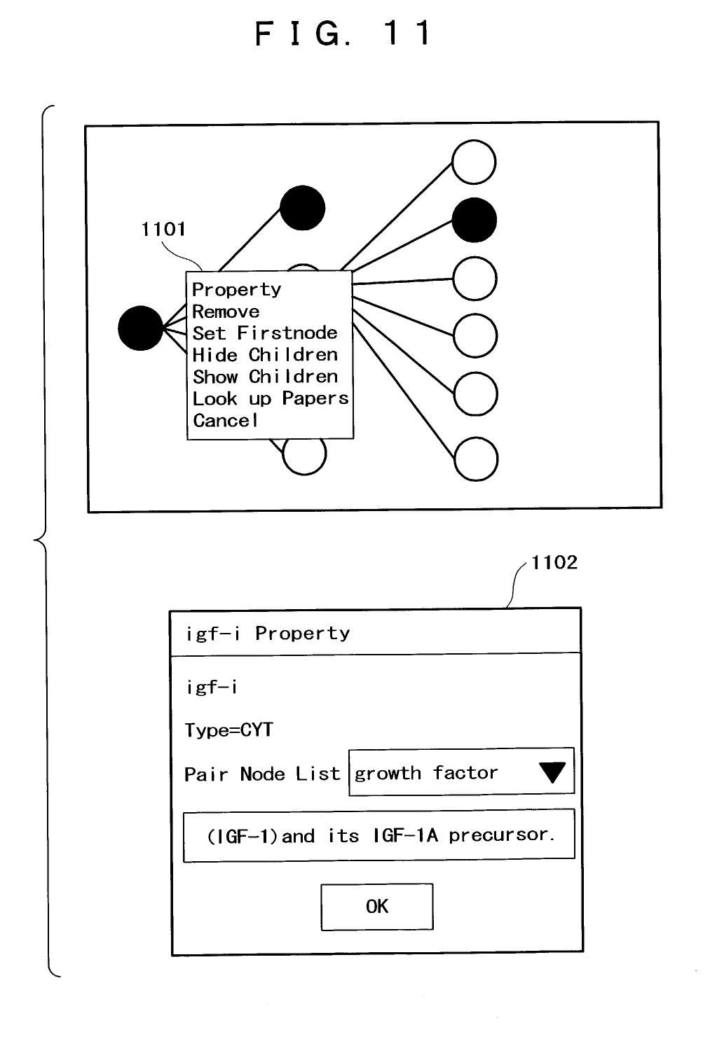

When you right-click a node, a pop-up menu 1101 as is shown in FIG. 11 appears. From the pop-up menu, the user can use the following actions.

Property

Shows the property of the node. A drop-down list listing the nodes having direct parent-child relation with the selected node appears. When you select a node from the list, the property of the node is shown. In the lower section of the page of FIG. 11, an example of the shown property of a node 1102 is shown. The property shown contains the following:

Node name (“igf-I” in the example shown)

Type Three upper-case alphabet letters designates the node type; for example, NUC that stands for Nucleotide.

Pair Node List A list of nodes having direct parent-child relation with the selected node is shown.

Information registered in a database or a sentence from literature including the substance name corresponding to the node is shown.

Remove

Removes a node. When a node removed, its children and descendants are also removed.

Set Firstnode

Sets the selected node as the tope-level node. After selecting Set Firstnode, when you select Start from the File menu, a systematic tree of binary relations originating from the selected node as the top-level node is rearranged.

Hide Children

Hides all nodes on the lower hierarchies than the selected node. This action can also be performed by double-clicking the node.

Show Children

Shows all nodes on the lower hierarchies than the selected node. This action can also be performed by double-clicking the node.

Look up Papers

Activates online search for information for the selected node (only when the viewer runs as an applet).

Cancel

Closes a menu.

(3) Edge (Line Between Nodes)

When you right-click an edge, a pop-up menu 1202 as is shown in FIG. 12 appears. From the pop-up menu, the user can use the following actions.

Property

Shows the property of the edge. In the middle section of the page of FIG. 12, an example of the shown property of an edge 1202 is shown. The property contains the button boxes respectively containing the names of the nodes connected in binary relation (two button boxes) at the top, a keyword designating interaction, and a significance value. When you click one of the button boxes, the property of the relevant node is shown. When you click the OK button, the property window closes.

Remove

Removes the edge and the nodes on its both ends.

Text

Activates online search for text by edge information. The edge information comprises the keyword designating the relation between the substances connected by the edge and its significance value. Search for text by the edge information is searching literature databases for texts including the same keyword as the keyword of the edge information. As results of search, a list of texts including the binary relation between the substances connected by the edge is shown.

Sentences

Activate online search for sentences by edge information. Search for sentences is searching literature databases for sentences including the same keyword as the keyword of the edge information. As results of search, a list of sentences including the binary relation between the substances connected by the edge is shown. In the sentences, the substance names and a verb or the like as the keyword are shown in color.

Edge Slider Panel

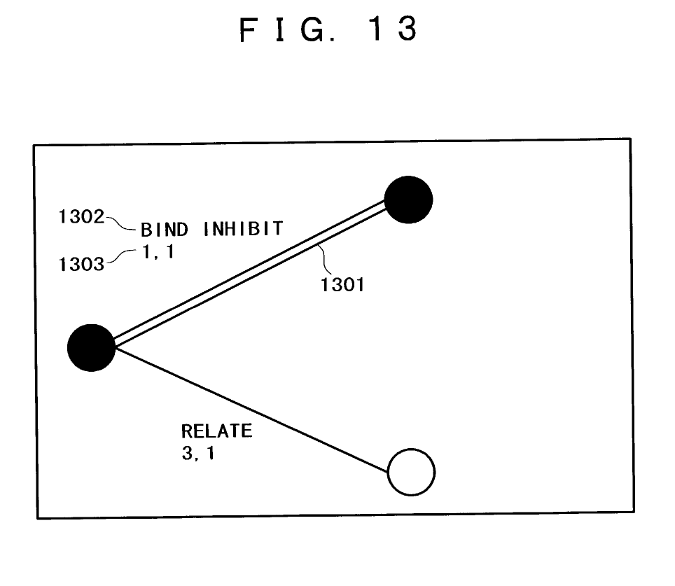

When you right-click on any part of the screen where nothing is shown, a pop-up menu 1201 is shown. When you select “Edge Slider Panel” from the pop-up menu 1201, an edge slider panel 1203 opens as is shown in the bottom section of the page of FIG. 12. The edge slider panel 1203 allows the user to select the edges to be shown or hidden, according to the conditions of the edges. As described in the Property section of edge, the edge has the keyword information designating interaction between the substances connected by the edge. The number of edges is determined by the number of keywords. The keyword 1320 can be set to be shown on the screen. For example, when an edge has two keywords “BIND” and “INHIBIT”, it is represented as two lines corresponding to the two keywords as is shown in FIG. 13. Numbers (1303) under BIND INHIBIT are significance values RF and GGR of the relation, obtained as described in Section 2.2.1.

Showing or Hiding Edges by Selecting Interaction Keywords

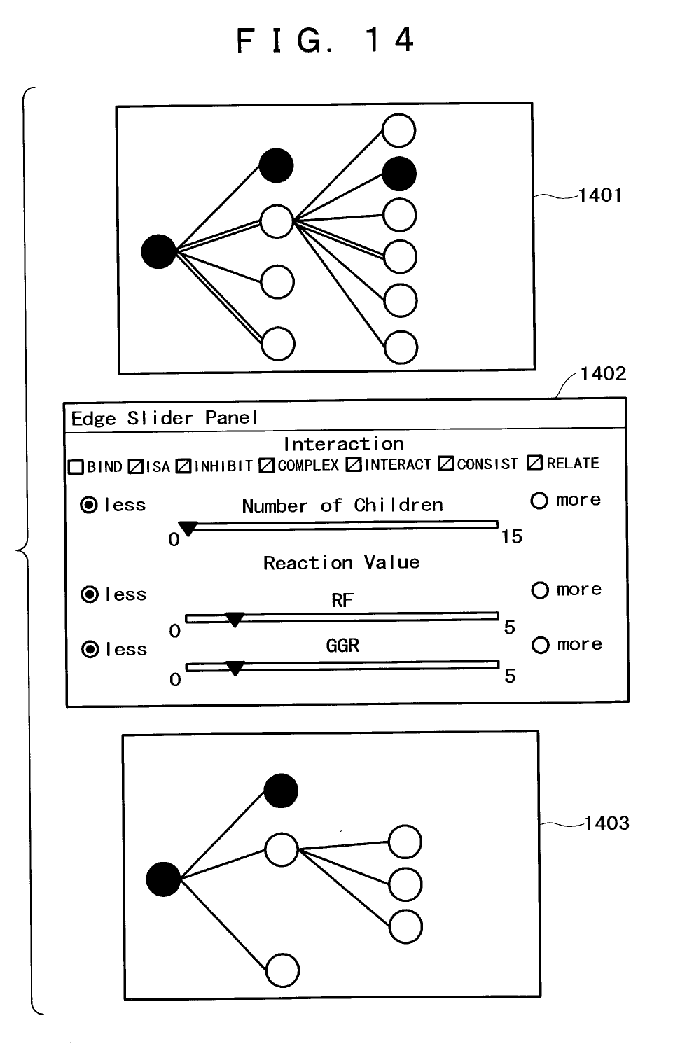

The viewer shows only the edges corresponding to the keywords checked in the checkboxes at the top of the edge slider panel. An example thereof is explained, using FIG. 14. When a systematic tree of binary relations is shown on a layout screen 1401 shown in the top section of the page of FIG. 14, the edge slider panel 1402 is activated. On the edge slider panel 1402, deselect the BIND checkbox among the checkboxes of the keywords designating interaction under label Interaction. Then, the BIND edges and the nodes connected by the edges are hidden in the layout 1403.

Showing or Hiding Nodes by Setting a Threshold of the Number of Children

Using the Number of Children slider in the middle section of the edge slider panel, the user can show or hide the nodes, according to the number of children of the nodes. For example, when the slider is set at 5, all nodes whose number of children is less than 5 or 5 and more are hidden. Isolated nodes because of disappearance of relation with another node are also hidden. Either “more” or “less” condition can be selected.

Showing or Hiding Edges by Setting a Threshold of Significance Value

Using the sliders in the lower section of the panel, the user can set a threshold of significance value by which the edges are shown. The user can set a threshold of binary relation significance values such as RF, GGR, and RTF detailed in Section 2.2.1. The minimum value of significance is 0 and the maximum value is 5. The greater the value, higher will be the significance. For example, when the slider is set at 3, only the edges having the significance value of less than 3 or 3 and more are shown. Either “more” or “less” condition can be selected. Shown edges become hidden in the same way as explained for FIG. 14 with the example of hiding edges by deselecting an interaction keyword.

3.2.2 List

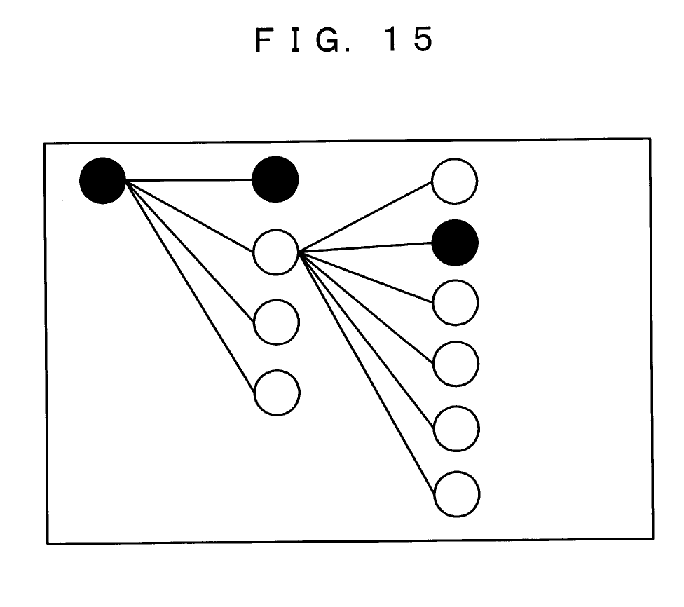

The viewer shows the binary relations listed from the left. The more distance (depth) from a principal node, the nodes and relation therebetween are positioned to the right. Other details of the “list” view are the same as the “simple” view. FIG. 15 shows an example of the “list” view.

3.2.3 Explorer

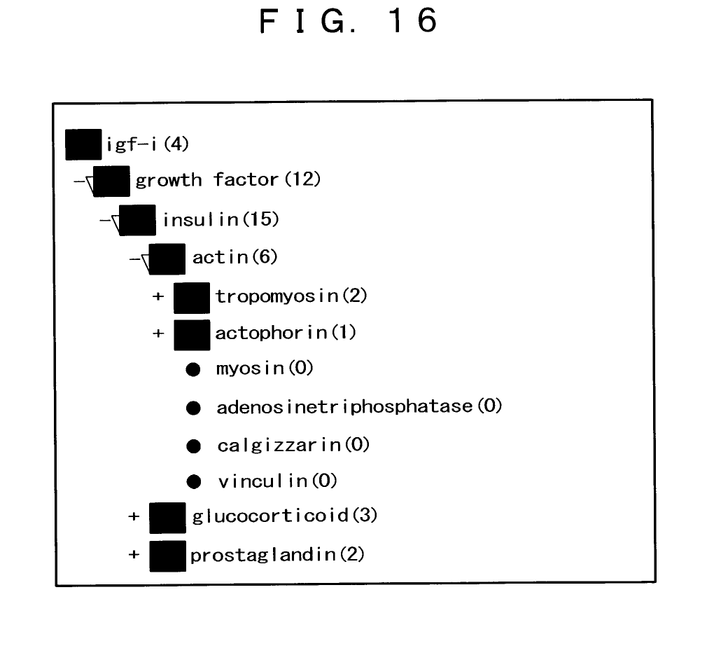

The viewer shows nodes of binary relations as folders as a common explorer does. A number shown at the right of each node is the number children that directly belong to the shown node. According to this number, the nodes are sorted and shown. FIG. 16 shows an example of the “explorer” view. In the “explorer” view, the user can perform the following actions.

(1) Switching between Showing and Hiding Children

By double-clicking a node or clicking the mark shown at the left of the node, the user can switch between showing and hiding the node's children.

(2) Pop-up Menu

When you right-click a node, a pop-up menu appears. From the pop-up menu, the user can perform the following actions.

Property

Shows the property of the node. Details are the same as described for the “simple” view.

SetFirstNode

Sets the selected node as the top-level node and rearranges other nodes originating from the node.

3.2.4 Animate

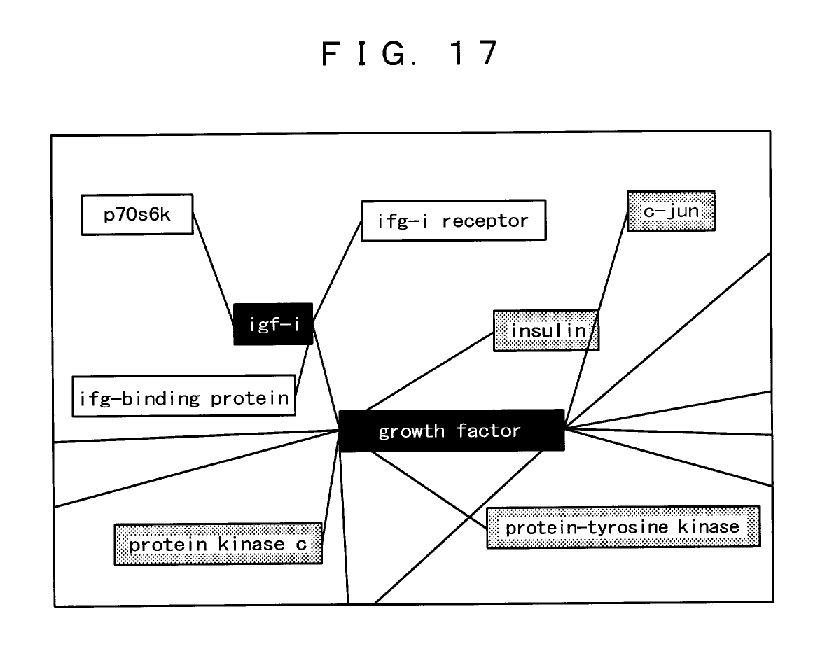

The viewer renders animation layout, using the binary relations. It fixes a node on which the focus is placed, keeping the distance between nodes constant. When you select the “animate” view, only the top-level node is shown. When you double-click the node, its children is shown. The nodes are shown in different colors like this: a node with its children hidden is red, a node without children is white, and a node with its children shown is orange. You can drag the nodes with a mouse. FIG. 17 shows an example of the “animate” view.

(1) Switching between Showing and Hiding Children

By double-clicking a node, the user can switch between showing and hiding its children.

(2) Pop-up Menu

When you right-click a node, a pop-up menu appears. From the pop-up menu, the user can perform the following actions.

Property

Shows the property of the node. Details are the same as described for the “simple” view.

Set First Node

Sets the selected node as the top-level node and hides all other nodes.

Show Children

Shows the children of the node.

Hide Children

Hides the children of the node.

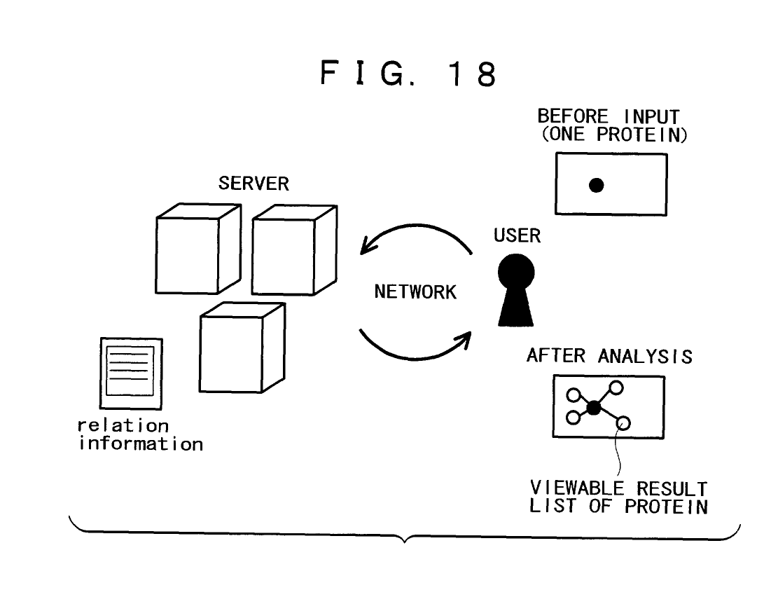

As is shown in FIG. 18, a system for presenting binary relations of the present invention can be configured to include a server in which the substance dictionary and data of binary relations between substances (see FIG. 2) extracted from databases are stored so that the user can access the data on the server via a network. When the user sends the server a substance name of interest via the network, the server retrieves substances having a binary relation with that substance and returns the substances and binary relations that are output to dynamic viewer described above. Using the functions of the dynamic viewer, the user can get information for the substances and binary relations with the substance of interest.

Furthermore, the present invention is preferably embodied as methods that are enumerated below:

(1) A method of inferring binary relations between two substances from descriptions in text, the method comprising the steps of retrieving a set of texts from which to extract substances related with each other from databases; converting each text in the text set to text including the weight vectors of substances appearing in the text which represent relative significance values of the substances, using an index of how many times a substance appears in the text and an index of how typically the substance is used in the text set; for two substances, obtaining an index of significance of a pair of the two substances from the weight vectors of the two substances in the text and the relation between the two substances in terms of locations where the two substances appear in the text, summing up the above indices obtained for all texts in the text set, inferring the index of possibility of an interrelation between the two substances; and, for two substances having the index of possibility of the interrelation greater than a predetermined threshold, presenting sentences in the text in which the two substances appear in pairs.

(2) A method of presenting binary relations between substances extracted from a set of texts stored in databases, the method comprising the steps of setting types of binary relations to be presented; and presenting binary relations matching the set types of binary relations, using nodes representing substances and edges representing binary relations between substances, each edge connecting two of the nodes.

(3) A method of presenting binary relations between substances extracted from a set of texts stored in databases, the method comprising the steps of setting conditions of significance values of binary relations to be presented; and presenting binary relations between two substances for which the binary relation significance values calculated, based on how many times the binary relation between two substances appears and peculiarity of the binary relation between two substances in the text set satisfy the set conditions, using nodes representing substances and edges representing binary relations between substances, each edge connecting two of the nodes.

(4) A method of presenting binary relations between substances recited in item (2) or (3), wherein the nodes are shown differently, according to the type of substance and/or the edges are shown differently, according to the type of binary relation.

(5) A method of presenting binary relations between substances as recited in any of items (2) to (4), further including the steps of selecting one of the edges shown; activating online text search by edge information of the selected edge; and presenting a list of texts including the binary relation between the two substances connected by the selected edge as search results.

(6) A method of presenting binary relations between substances as recited in any of items (2) to (4), further including the steps of selecting one of the edges shown; activating online sentence search by edge information of the selected edge; and presenting a list of sentences in text including the binary relation between the two substances connected by the selected edge as search results.

(7) A method of presenting binary relations between substances as recited in any of items (2) to (6), wherein the above substance is a protein.

According to the present invention, useful binary relations between substances such as proteins, genes, and low-molecular-weight substances can be obtained from databases in which a huge amount of literature is stored and the obtained binary relations can be visually presented. This makes it easy to obtain important information about relations between substances which have heretofore been buried in the databases and can make a great contribution to the medical industry and developing medicines.

The foregoing invention has been described in terms of preferred embodiments. However, those skilled, in the art will recognize that many variations of such embodiments exist. Such variations are intended to be within the scope of the present invention and the appended claims.

What is claimed is:

1. A method of constructing a substance dictionary, the method comprising the steps of:
collecting a term group consisting of a substance name and its synonyms and cross-reference information specifying that two or more different names are used to refer to the same substance from a plurality of databases;
comparing the thus collected term groups and combining the term groups including the same name or synonym; and
combining the term groups expressing the same substance, using the cross-reference information.

2. A method of constructing a substance dictionary as recited in claim 1, wherein said substance is a protein.

3. A method of extracting a compound word expressing a substance name from text, the method comprising the steps of:
segmenting said text into token units and extracting a coined word (a main keyword) peculiar to said substance in compliance with a predetermined word formation rule and a word (function keyword) registered in a list of words predetermined to designate the function and property of said substance;
in sentences of said text including a main keyword extracted, extending the main keyword by combining one or more symbols, words and phrases, other main keywords or function keywords preceding or following said main keyword with it, according to a predetermined rule; and
in sentences of said text, combining extracted main and function keywords or extracted main and function keywords and the thus extended main keyword into a noun phrase, according to a predetermined pattern.

4. A method of constructing a substance dictionary as recited in claim 3, wherein said substance is a protein.

5. A method of extracting binary relations between substances from text, the method comprising the steps of:
preparing a dictionary into which nouns, each expressing a substance, have been registered;
registering verbs, each expressing a binary relation between substances;
manually or automatically collecting sentence patterns, each including one of said verbs and two nouns, and creating automatons of the sentence patterns;
retrieving text from databases;
subjecting a sentence in the retrieved text to the process of one of said automatons on the condition that two nouns have been registered in said dictionary; and
outputting the two nouns respectively expressing two substances and a verb expressing a binary relation between the substances when said sentence has been accepted by the one of said automatons.
